(19) United States
(12) Patent Application Publication
(10) Pub. No.: US 2026/0071586 A1
(43) Pub. Date: Mar. 12, 2026

(54) Real-Time On-Board Fuel Classification in Internal Combustion Engines

(71) Applicant: Southwest Research Institute, San Antonio, TX (US)

(72) Inventors: Khanh Duc Cung, San Antonio, TX (US); Travis Glenn Kostan, Alamo Heights, TX (US); Garrett Lance Anderson, Seguin, TX (US); Christopher Alan Sharp, San Antonio, TX (US); Daniel Christopher Bitsis, JR., Helotes, TX (US)

(21) Appl. No.: 19/321,188

(22) Filed: Sep. 6, 2025

Related U.S. Application Data
(60) Provisional application No. 63/694,170, filed on Sep. 12, 2024.

(51) Int. Cl. F02D 41/24; F02D 41/00

(52) U.S. Cl. CPC F02D 41/2409; F02D 41/0097; F02D 2200/08

(57) ABSTRACT

A method of identifying an unknown fuel used by an internal combustion engine in a vehicle. A set of sensor models is prepared, each model representing measurements of an on-board sensor for different known fuels. The sensor models are for sensors from various sensors carried on-board the vehicle, such as a crank sensor, NOx sensor, soot sensor, and exhaust temperature sensor. While the vehicle is in operation, measurement data from two or more sensors of the sensor group is acquired and delivered to an on-board fuel identification process, which applies a statistical analysis to identify the fuel as being one of the known fuels.

### CROSS-REFERENCE TO RELATED APPLICATION

This patent application claims the filing date benefit of U.S. Prov. App. No. 63/694170, filed Sep. 12, 2024, entitled Real-Tune Real-Time On-Board Fuel Classification in Reciprocating Internal Combustion Engines.

### BACKGROUND OF THE INVENTION

Internal combustion engines have been using fossil-derived fuels for many decades. Traditionally, there have been two primary fuels: diesel and gasoline. However, energy companies are developing new fuels that can serve as alternatives to conventional fuels, aiming to improve fuel consumption and achieve more sustainable production. Fuels such as renewable diesel and biodiesel are examples of alternative fuels. Together with their blends and future use of other sustainable fuels (e.g., methanol, ethanol, ammonia, etc.), there can exist a complexity in fuel options depending on region, cost, and engine compatibility. Identification of the fuel is essential to determining the compatibility of the fuel and the engine.

### BRIEF DESCRIPTION OF DRAWINGS

FIG. 1 illustrates a number of fuel characteristics and how they vary among four different fuels.

FIG. 2-5 illustrate four sensors that may be used in identifying (classifying) fuels.

FIG. 6 illustrates how a fuel matrix is used to represent fuels and fuel properties for statistical models.

FIG. 7 Illustrates how two sensor parameters (ignition and fuel sensor) can be used to identify fuels.

FIG. 8 illustrates a vehicle having an on-board fuel identification system in accordance with the invention.

### DETAILED DESCRIPTION OF THE INVENTION

The following description is directed to a method and system to detect the type of fuel being used in an operating internal combustion engine. The fuel is identified or “sensed” by one or more sensors installed around the engine or in the fuel stream that serve as surrogates for some fuel properties. For example, a flex-fuel sensor originally developed for ethanol/gasoline application has demonstrated good sensitivity with varying biodiesel content. As other examples, a production accelerometer (knock sensor) or crankshaft sensor can provide analysis and input on the combustion performance of fuels, such as the start of ignition. These sensors provide the basis for a method to classify fuels because they indicate fuel properties, such as oxygen content, cetane number, and heating value. The combination of these sensed fuel properties is used by a classification process to classify the fuel. In sum, fuels can be classified using a variety of sensors (multi-sensor approach).

Given an unknown fuel, the method collects measurement data from on-board sensors. Sensors are installed around the engine or in the fuel or exhaust stream to detect properties of the fuel. Once several properties of the fuel or effects of its combustion are detected and stored, this data is combined and analyzed to determine a fuel that best matches the properties indicated by the measurement data. Based on the proximity of the match to the expected output of the fuel, the fuel can be classified into a known category.

With the fuel having been identified, there are significant opportunities to re-calibrate the engine for optimal performance, to reduce emissions and fuel consumption, and thereby improve environmental and economic aspects of vehicle operation. Fuel identification can be critical for the long-term performance of the emission control system.

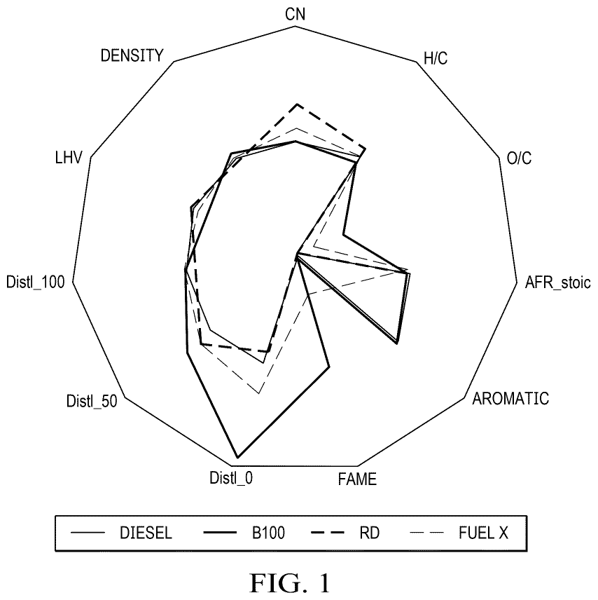

FIG. 1 illustrates a number of fuel properties and how they vary among four different fuels, which are diesel, neat biodiesel (B100), neat renewable diesel (RD), and Fuel X. Fuel X is an unknown fuel. The diesel fuel is a conventional fuel, and the others can be described as “alternative fuels”.

The various fuel characteristics include density, cetane number (CN), ignition delay, saturation, ratio of hydrogen to carbon atoms (H/C), oxygen content (O/C), stoichiometric air-fuel ratio (AFR-stoic), the percentage of chemical compounds in a fuel, such as benzene, toluene, and xylenes, that contain benzene rings (aromatic), Fatty Acid Methyl Ester (FAME) content, distillate rate (Distl-0, Distl-50, Distl-100), and Lower Heating Value (LHV).

FIG. 1 indicates that if fuel characteristics are measured, directly or indirectly, for a particular fuel, the variations can be useful in identifying a fuel.

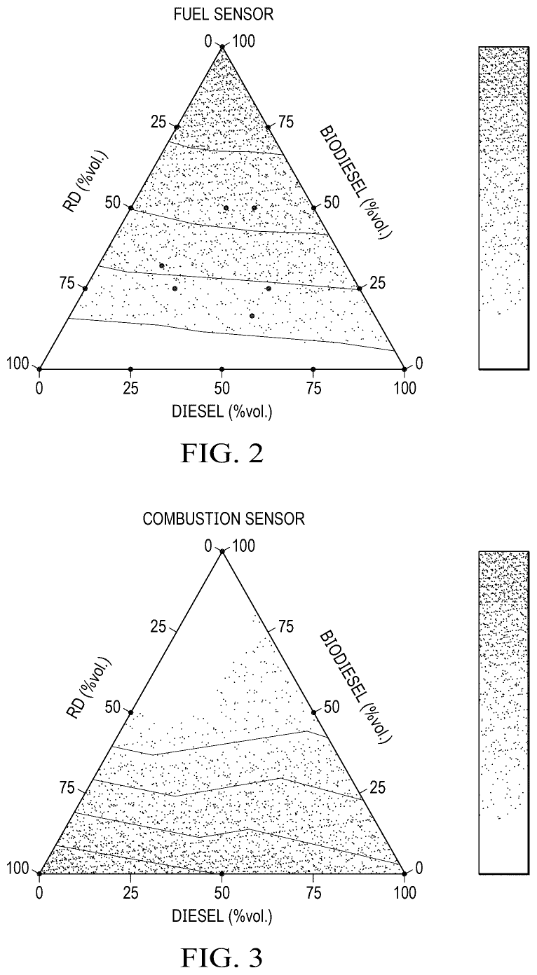

FIG. 2-5 illustrate four sensors that may be used in identifying (classifying) fuels. As explained below, additional sensors may be used to measure or infer additional fuel characteristics. Because fuels have different characteristics as indicated in FIG. 1, certain sensors will output measurements that also vary among fuel types.

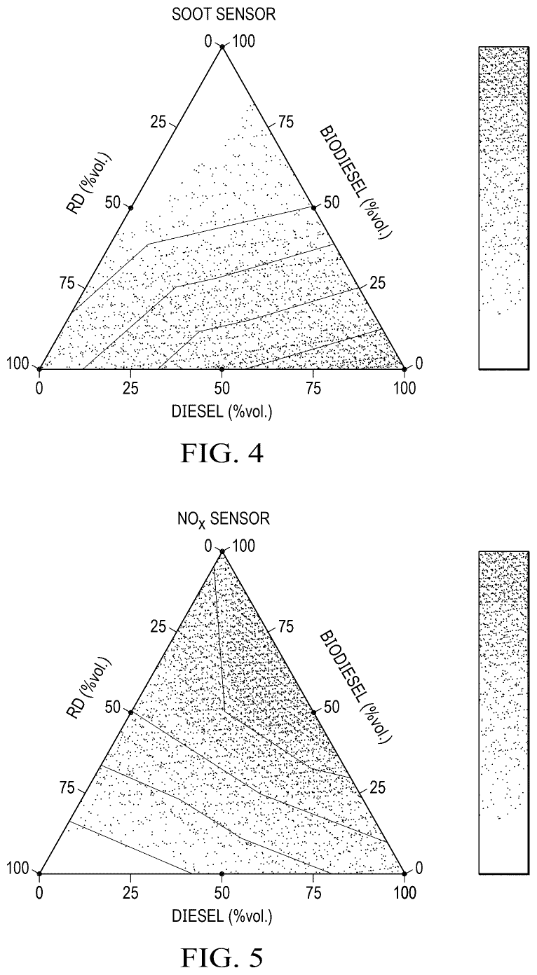

In FIG. 2-5, the sensors are a fuel sensor (FIG. 2), combustion sensor (FIG. 3), soot sensor (FIG. 4), and NOX sensor (FIG. 5). The combustion sensor can be an accelerometer knock sensor or a crank sensor, or a combination of both of these sensors. Both sensors have successfully demonstrated their potential to describe the characteristics of a combustion event. Some of these sensors are commonly installed on-board vehicles using internal combustion engines. The fuel sensor is a sensor often used for flex fuels and measures fuel conductivity. Each of these sensors provides a measurement output that can differ depending on what fuel is being used for combustion.

The triangles (ternary plot) represent relative amounts of three fuels: renewable diesel, diesel, and biodiesel. For each fuel, the neat concentration is shown at a corner. For each sensor, the sensed measurements vary depending on the fuel. For example, for diesel fuel, fuel sensor measurements will be lower and soot sensor measurements will be higher as compared to biodiesels. Renewable diesel can be differentiated from biodiesel and diesel via soot and NOx sensors. Combination characteristics of these fuels are also relatively well captured from the selected sensors, such as the accelerometer and the crank sensor, especially when analyzed at a selected engine operating condition.

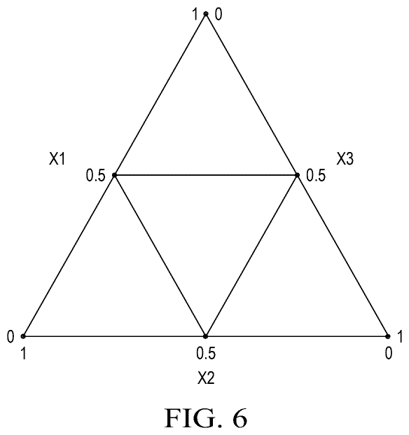

FIG. 6 illustrates an example of fuel matrix to create a boundary of fuel properties for the application of a statistical model. Three fuels (X1, X2, and X3) represent neat fuels (diesel, biodiesel and renewable diesel). The midpoints represent blends of these fuels. This six-point lattice design represents a model with three fuels and two mixture components. Other models for additional fuels and components may be used.

These models may be used as the basis for statistical analysis of sensor measurements applied to the models. For example, the model may serve as matrices for a neural net structure, which each sensor being an input channel to the neural net. In a neural network, a matrix is a grid of numbers (specifically, the weights) that represent the strength of connections between neurons and is used to perform the calculations that process information, transforming input data through layers to produce an output. Matrices organize the network's parameters and data into a structured format, allowing for efficient mathematical operations that are fundamental to how a neural network learns and makes predictions. Other machine learning processes, such as support vector machines, are also suitable. In general, given data points where each belong to a class, the goal is to decide which class a new data point is in.

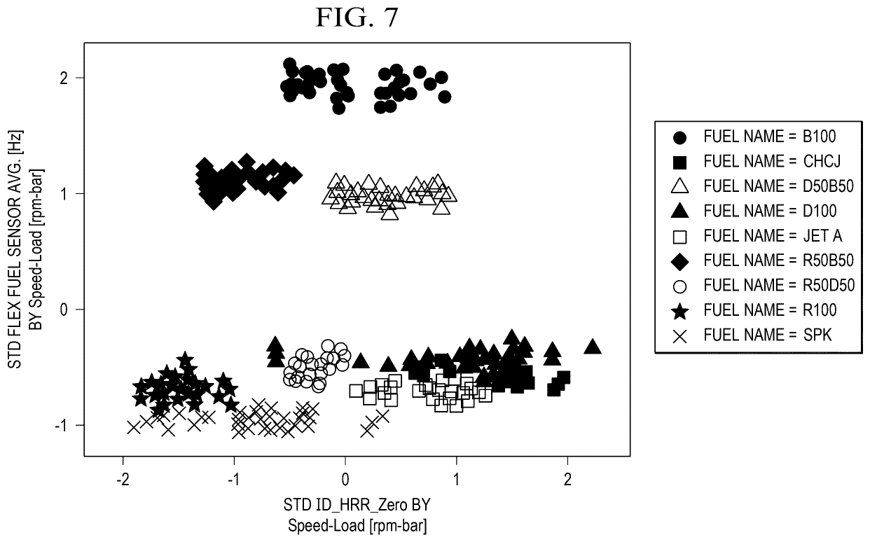

FIG. 7 is the output of sensor measurements applied to a support vector process and illustrates how two sensor parameters (ignition and fuel sensor) can be used to identify fuels. For ignition sensing, ID HRR Zero refers to the point at which ignition location is defined by the Heat Release Rate (HRR) rising above zero. This sensor is used to mark the beginning of combustion. Nine different fuels were sensed at different speed-load operating conditions using a support vector machine process. The certainty level of the two-sensor classification can be improved by reconstructing the data analysis and selecting specific data from a particular engine operating condition.

For identifying an unknown fuel being consumed by a particular vehicle, the method begins with selection of parameters available from sensors on-board that vehicle. The most suitable parameters are expected to be measurements from a fuel sensor, crank sensor, NOx sensor, soot sensor, and exhaust temperature sensor. However, the method is not limited to these sensors and others may be used such as rail pressure or injection timing. In some embodiments, the vehicle's engine control unit may already be configured to collect measurement data and that data may then be delivered to the classification process.

The fuel identification method will attempt to “sense” the fuel using available on-board sensor measurements. These measurement types were established or calibrated using previous fuel and engine measurements and operating conditions. Based on sensor measurement data and using the statistical analysis discussed herein, a particular fuel can be classified into its fuel type. Various statistical analyses methods may be used to apply the sensor measurement data (and/or engine control unit data) to predetermined models of properties of known fuels and combine the results.

The method can be coupled with machine learning to assist the fuel classification process and reduce the number of channels for less intensive data processing. For example, machine learning can identify optionally available channels (sensor or engine control unit outputs) more efficiently.

A feature of the method is a selected approach to analyzing the measurement data. This selection can be made by the engine operator or automatically depending on the real-time engine condition. Three available approaches are:
1) A look-up calibration approach: fixed or referenced engine operating condition
2) A relative calibration approach: a series of engine operating conditions either purposely controlled or real-time measurement of a real-life engine/vehicle operation
3) An ECU-based approach, which is similar to the look-up and relative approaches, but limits the channels to those from the vehicle's engine control unit (ECU). This allows vehicle manufacturers to implement the fuel identification method using their particular on-board sensors.

For training purposes, if the identification process cannot identify the fuel under a series of engine operating conditions and available on-board parameters, it will report the uncertainty and register the fuel being operated as new fuel. Ultimately, the process will learn to identify the specific operating conditions and on-board parameters that will improve the identification results.

Once a fuel has been identified, this information can be used for further purposes. Examples are for engine and emissions control and for improving durability. Engine and emissions control are directed to optimizing engine and emission performance once the engine has learned enough about the fuel. For durability, the vehicle will have a history of the fuel type used during a period of time. Different fuels can impact various engine components, such as injectors, pistons, and after-treatment devices. A record can be created to establish a time history, combined with the known sensitivity of an engine component, to estimate the remaining lifetime of the component or the time until it needs servicing.

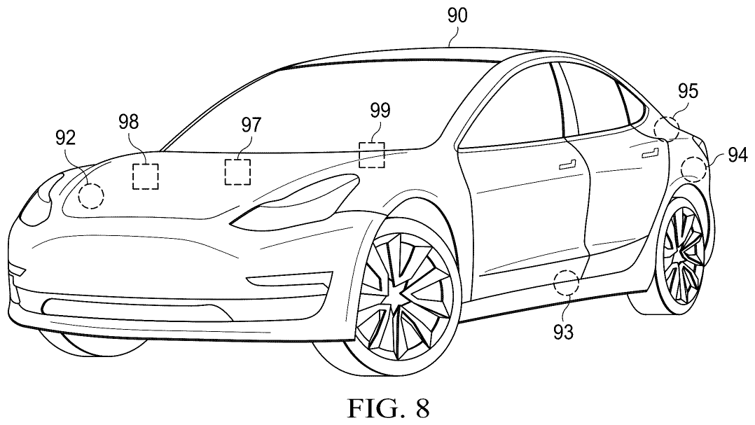

FIG. 8 illustrates a vehicle 90 having an on-board fuel identification system in accordance with the invention. Vehicle 90 is equipped with several of the on-board sensors described herein. These may include a crank sensor 92, NOx sensor 93, soot sensor 94, and exhaust temperature sensor 95, as well as other sensors described herein and not explicitly shown in FIG. 8. As indicated above, a particular fuel identification system may use some combination of these sensors. Typically, at least three sensors are used.

Measurement data from sensors 92 93 94 and 95 is delivered to an on-board fuel identification process 97, which analyzes and correlates the measurement data as described above to determine what fuel best matches the fuel properties indicated by the measurement data. The identification process is performed entirely on-board and no external input or communication is required.

The identification system may include an operator interface 99, to which the identified fuel type is reported. The fuel type may be reported to other control systems, such as the emission control system as input to optimize emissions control for that fuel. Fuel identification may also be reported externally, such as to the cloud connection and telematics systems, for benefits such as fleet operation.

1. A method of identifying an unknown fuel used by an internal combustion engine in a vehicle, the vehicle having a number of on-board sensors, comprising:
developing a set of sensor models, each model representing measurements of an on-board sensor for different known fuels;
wherein the sensor models are for sensors from the following sensor group:
crank sensor, NOx sensor, soot sensor, and exhaust temperature sensor;
while a vehicle is in operation, acquiring measurement data from two or more sensors of the sensor group;
delivering the measurement data to an on-board fuel identification process that applies statistical analysis to the measurement data; and
using the fuel identification process to identify the unknown fuel as being one of the different known fuels.

2. The method of claim 1, wherein the vehicle has an engine control unit and further comprising delivering data from the engine control unit to the fuel identification process for use in identifying the fuel.

3. The method of claim 1, wherein the statistical analysis is performed using a neural network.

4. The method of claim 1, wherein the statistical analysis is performed using support vector processing.

5. The method of claim 1, further comprising delivering the results of the fuel identification process to an emissions control system of the vehicle.

6. The method of claim 1, further comprising determining an engine operating condition during which the acquiring measurement data step shall occur.

7. The method of claim 1, further comprising using a look-up table to determine an engine operating condition during which the acquiring measurement data step shall occur.

8. An on-board system for identifying an unknown fuel used by an internal combustion engine in a vehicle;
a set of two or more on-board sensors from the following sensor group: crank sensor, NOx sensor, soot sensor, and exhaust temperature sensor;
a set of sensor models, each model representing measurements of an on-board sensor for different known fuels;
an on-board fuel identification process that receives measurement data from two or more of the sensors and applies statistical analysis to the measurement data while the vehicle is in operation and identifies the unknown fuel as being one of the different known fuels.

9. The system of claim 8, wherein the vehicle has an engine control unit and the fuel identification process receives data from the engine control unit for use in identifying the fuel.

10. The system of claim 8, wherein the fuel identification process is implemented with a neural network.

11. The system of claim 8, wherein the fuel identification process is implemented with support vector processing.

12. The system of claim 8, further comprising a stored look-up table to determine an engine operating condition during which the measurement data step shall be acquired.
